(19) United States
(12) Patent Application Publication
(10) Pub. No.: US 2026/0065415 A1
(43) Pub. Date: Mar. 5, 2026

(54) IMAGE PROCESSING METHOD AND RELATED EQUIPMENT

(71) Applicant: Beijing Zitiao Network Technology Co., Ltd., Beijing (CN)

(72) Inventors: Fei Dai, Beijing (CN); Honglun Zhang, Beijing (CN)

(21) Appl. No.: 19/317,455

(22) Filed: Sep. 3, 2025

(30) Foreign Application Priority Data
Sep. 4, 2024 (CN) 202411238486.2

(51) Int. Cl. G06T 3/40; G11B 27/031; G11B 27/06

(52) U.S. Cl. CPC G06T 3/40; G11B 27/031; G11B 27/06

(57) ABSTRACT

The invention provides an image processing method and related device. The method comprises: obtaining a first image; generating a second image based on the first image, the second image comprising image content of the first image; generating a target video by performing dynamic scaling conversion between the first image and the second image based on a preset speed.

### CROSS-REFERENCE TO RELATED APPLICATION(S)

This application claims priority to Chinese Application No. 202411238486.2 filed Sep. 4, 2024, the disclosure of which is incorporated herein by reference in its entirety.

### FIELD

The invention relates to the technical field of computers, in particular to an image processing method and related equipment.

### BACKGROUND

At present, image processing can automatically expand the content of the image, making it look more complete or have a wider field of vision.

### SUMMARY

The present disclosure provides an image processing method and related equipment, in order to solve the technical problems of poor image processing effect due to the single expanded content of the image and the disharmony between the image and the original image to a certain extent.

In a first aspect of the present disclosure, there is provided an image processing method, comprising:
obtaining a first image;
generating a second image based on the first image, the second image including image content of the first image;
generating a target video by performing dynamic scaling conversion between the first image and the second image based on a preset speed.

In a second aspect of the present disclosure, there is provided an image processing apparatus, comprising:
an image obtaining module, configured to obtain a first image;
an image generation module, configured to generate a second image based on the first image, the second image including the image content of the first image; and
an image scaling module, configured to generate a target video by perform dynamic scaling conversion between the first image and the second image based on a preset speed.

In a third aspect of that present disclosure, there is provided an electronic device including one or more processor and a memory; and one or more programs, wherein the one or more programs are stored in the memory and executed by the one or more processors, the programs including instructions for performing the method according to the first aspect.

In a fourth aspect of that present disclosure, there is provided a nonvolatile computer-readable storage medium containing a computer program which, when executed by one or more processors, causes the processor to perform the method of the first aspect.

In a fifth aspect of that present disclosure, there is provided a computer program product including computer program instructions which, when executed on a computer, cause the computer to perform the method described in the first aspect.

As can be seen from the above, an image processing method and related equipment provided by the present disclosure generate a second image containing more details based on the first image, which is reasonable in content and more consistent with the style of the first image; the first image and the second image are dynamically scaled to generate the target video, which visually realizes the dynamic scaling effect between the original first image and the expanded second image, and improves the quality and visual effect of image processing.

### BRIEF DESCRIPTION OF THE DRAWINGS

In order to explain the technical scheme in this disclosure or related technology more clearly, the drawings needed to be used in the description of the embodiment or related technology will be briefly introduced below. Obviously, the drawings in the following description are only the embodiments of this disclosure. For ordinary people in the field, other drawings can be obtained according to these drawings without creative work.

FIG. 1 is a schematic diagram of an image processing architecture of an embodiment of the present disclosure.

FIG. 2 is a schematic diagram of the hardware structure of an exemplary electronic device according to an embodiment of the present disclosure.

FIG. 3 is a flowchart of an image processing method according to an embodiment of the present disclosure.

FIGS. 4A-4F are schematic diagrams of generating a second image based on a first image according to an embodiment of the present disclosure.

FIGS. 5A-5C are schematic diagrams of a target video according to an embodiment of the present disclosure.

FIG. 6 is a schematic diagram of an image processing device according to an embodiment of the present disclosure.

### DETAILED DESCRIPTION OF EMBODIMENTS

The existing image expansion content is single and the effect is not harmonious with the original image, which leads to poor image processing effect.

In order to make the objectives, technical solutions and advantages of the present disclosure more clearly understood, the present disclosure is further described in detail below in combination with specific embodiments and with reference to the accompanying drawings.

It should be noted that, unless otherwise defined, the technical terms or scientific terms used in the embodiments of the present disclosure should be understood by people with ordinary skills in the field to which the present disclosure belongs. The “first”, “second” and similar words used in the embodiments of the present disclosure do not indicate any order, quantity or importance, but are only used to distinguish different components. “Including” or “comprising” and similar words mean that the elements or objects appearing before the word cover the elements or objects listed after the word and their equivalents, without excluding other elements or objects. “Connect” or “connected” and similar words are not limited to physical or mechanical connections, but can include electrical connections, whether direct or indirect. “Up”, “down”, “left”, “right” and the like are only used to indicate relative positional relationships. When the absolute position of the described object changes, the relative positional relationship may also change accordingly.

It is understandable that before using the technical solutions disclosed in the embodiments of the present disclosure, the types, scope of use, usage scenarios, etc. of the personal information involved in the present disclosure should be informed to the user and the user's authorization should be obtained in an appropriate manner in accordance with relevant laws and regulations.

For example, in response to receiving an active request from a user, a prompt message is sent to the user to clearly prompt the user that the operation requested to be performed will require obtaining and using the user's personal information. Thus, the user can autonomously choose whether to provide personal information to software or hardware such as an electronic device, application, server, or storage medium that performs the operation of the technical solution of the present disclosure according to the prompt message.

As an optional but non-limiting implementation, in response to receiving an active request from the user, the prompt information may be sent to the user in the form of a pop-up window, in which the prompt information may be presented in text form. In addition, the pop-up window may also carry a selection control for the user to choose “agree” or “disagree” to provide personal information to the electronic device.

It is understandable that the above notification and the process of obtaining user authorization are merely illustrative and do not constitute a limitation on the implementation of the present disclosure. Other methods that meet the relevant laws and regulations may also be applied to the implementation of the present disclosure.

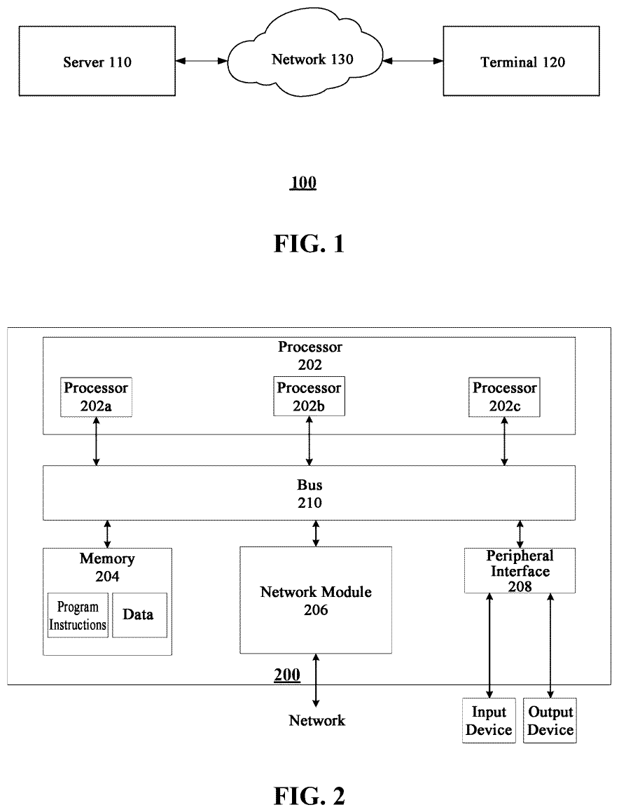

FIG. 1 shows a schematic diagram of an image processing architecture of an embodiment of the present disclosure. Referring to FIG. 1, the image processing architecture 100 may include a server 110, a terminal 120, and a network 130 that provides a communication link. The server 110 and the terminal 120 may be connected via a wired or wireless network 130. The server 110 may be an independent physical server, or a server cluster or distributed system composed of multiple physical servers, or a cloud server that provides basic cloud computing services such as cloud services, cloud databases, cloud computing, cloud functions, cloud storage, network services, cloud communications, middleware services, security services, and CDN.

The terminal 120 may be implemented in hardware or software. For example, when the terminal 120 is implemented in hardware, it may be various electronic devices having a display screen and supporting page display, including but not limited to smart phones, tablet computers, e-book readers, laptop portable computers, and desktop computers, etc. When the terminal 120 device is implemented in software, it may be installed in the electronic devices listed above; it may be implemented as multiple software or software modules (such as software or software modules used to provide distributed services), or it may be implemented as a single software or software module, which is not specifically limited here.

It should be noted that image processing method provided in the embodiment of the present application can be executed by the terminal 120 or by the server 110. It should be understood that the number of terminals, networks and servers in FIG. 1 is only for illustration and is not intended to limit the number of terminals, networks and servers. Any number of terminals, networks and servers may be provided as required.

FIG. 2 shows a schematic diagram of the hardware structure of an exemplary electronic device 200 provided by an embodiment of the present disclosure. As shown in FIG. 2, the electronic device 200 may include: a processor 202, a memory 204, a network module 206, a peripheral interface 208, and a bus 210. The processor 202, the memory 204, the network module 206, and the peripheral interface 208 are connected to each other in communication within the electronic device 200 through the bus 210.

The processor 202 may be a central processing unit (CPU), an image processor, a neural network processor (NPU), a microcontroller (MCU), a programmable logic device, a digital signal processor (DSP), an application specific integrated circuit (ASIC), or one or more integrated circuits. The processor 202 may be used to perform functions related to the technology described in the present disclosure. In some embodiments, the processor 202 may also include multiple processors integrated into a single logical component. For example, as shown in FIG. 2, the processor 202 may include multiple processors 202a, 202b, and 202c.

The memory 204 may be configured to store data (e.g., instructions, computer codes, etc.). As shown in FIG. 2, the data stored in the memory 204 may include program instructions (e.g., program instructions for implementing the image processing method of the embodiment of the present disclosure) and data to be processed (e.g., the memory may store configuration files of other modules, etc.). The processor 202 may also access the program instructions and data stored in the memory 204, and execute the program instructions to operate on the data to be processed. The memory 204 may include a volatile storage device or a non-volatile storage device. In some embodiments, the memory 204 may include a random access memory (RAM), a read-only memory (ROM), an optical disk, a magnetic disk, a hard disk, a solid-state drive (SSD), a flash memory, a memory stick, etc.

The network module 206 can be configured to provide the electronic device 200 with communication with other external devices via a network. The network can be any wired or wireless network capable of transmitting and receiving data. For example, the network can be a wired network, a local wireless network (e.g., Bluetooth, WiFi, near field communication (NFC), etc.), a cellular network, the Internet, or a combination thereof. It is understood that the type of network is not limited to the above specific examples. In some embodiments, the network module 206 can include any number of network interface controllers (NICs), radio frequency modules, transceivers, modems, routers, gateways, adapters, cellular network chips, etc., in any combination.

The peripheral interface 208 can be configured to connect the electronic device 200 to one or more peripheral apparatus to achieve information input and output. For example, the peripheral apparatus can include input devices such as a keyboard, a mouse, a touch pad, a touch screen, a microphone, and various sensors, and output devices such as a display, a speaker, a vibrator, and an indicator light.

The bus 210 may be configured to transmit information between various components of the electronic device 200 (eg, the processor 202, the memory 204, the network module 206, and the peripheral interface 208), such as an internal bus (eg, a processor-memory bus), an external bus (USB port, PCI-E bus), and the like.

It should be noted that, although the architecture of the electronic device 200 only shows the processor 202, the memory 204, the network module 206, the peripheral interface 208 and the bus 210, in the specific implementation process, the architecture of the electronic device 200 may also include other components necessary for normal execution. In addition, it can be understood by those skilled in the art that the architecture of the electronic device 200 may also only include the components necessary for implementing the embodiments of the present disclosure, and does not necessarily include all the components shown in the figure.

Related image expansion application technologies often contain generative adversarial network (GAN) components, resulting in deficiencies in the expansion effect in many aspects. For example, since the content generated by GAN is sometimes not highly correlated with the original image, the expanded area often appears empty and lacks details, making the connection between the generated content and the original image unnatural. It mainly focuses on simply increasing the spatial sense of the image, but fails to effectively enrich the content of the expanded area, resulting in the effect of the expanded image not being visually rich and reasonable. In addition, the content generated by GAN sometimes has inconsistencies, such as discontinuity in texture or object shape, which further affects the overall quality and visual experience of the expansion. In addition, users need to manually expand the image multiple times during use, and often need to operate on multiple different tools before splicing, which not only increases the complexity of the user's operation, but also reduces work efficiency. Manually expanding the image multiple times is not only time-consuming and laborious, but there may also be subtle differences between each expansion, which may appear incoherent in the final synthesized video, further affecting the quality of the final video. In addition, cross-tool operations increase the risk of data transmission and compatibility issues, making the entire expansion process cumbersome and unstable, and difficult to meet the needs of efficient and convenient use. Therefore, how to improve the visual effect and quality of image expansion has become a technical problem that needs to be solved urgently.

In view of this, the embodiments of the present disclosure provide an image processing method and related devices. By generating a second image containing more details based on a first image, the second image has reasonable content and is more consistent with the style of the first image; and a dynamical scaling conversion is performed between the first image and the second image to generate a target video, a dynamic scaling effect between the original first image and the expanded second image is visually achieved, thereby improving the quality and visual effect of image processing.

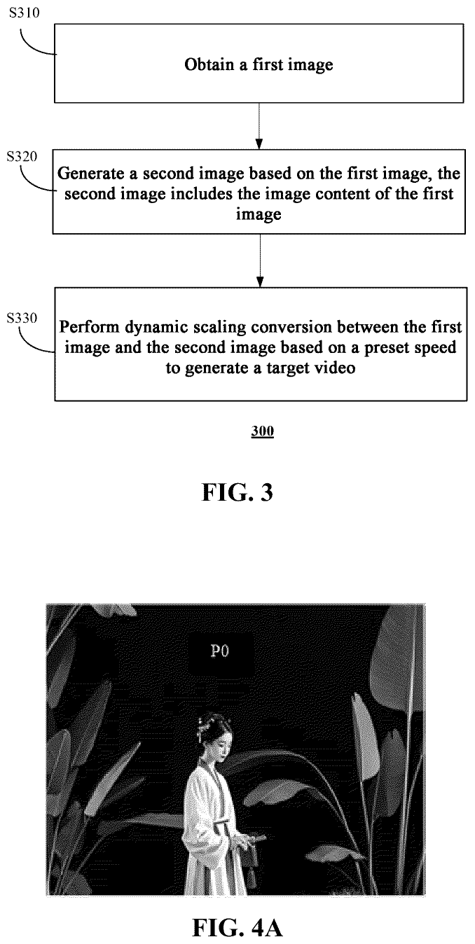

Referring to FIG. 3, FIG. 3 shows a schematic flow chart of an image processing method according to an embodiment of the present disclosure. The image processing method according to an embodiment of the present disclosure can be deployed on a terminal or a server. In FIG. 3, the image processing method 300 can further include the following steps.

At step S310, a first image is obtained.

Among them, the first image may refer to an image to be processed, which may be any image uploaded or provided by a user in a variety of ways, or an intermediate image according to an image processing method of an embodiment of the present disclosure. Specifically, a user may trigger a corresponding control in a corresponding interface to select an image to be processed. For example, in an image editing software, a user may select a photo from a photo library of a computer or mobile phone, and submit it to the system by clicking an “upload” button or dragging and dropping a file to a designated area to edit the photo. The first image may also be an image captured in real time by a user using an image acquisition device, such as a camera. The first image may also be an image downloaded via a network, such as an image shared on a social media platform.

At step S320, a second image is generated based on the first image, the second image including image content of the first image.

The second image may refer to an image obtained after content expansion processing of the first image, which may include all the contents of the first image and increase corresponding image contents, for example, may include adding new elements to the image.

In some embodiments, generating a second image based on the first image comprises:
extracting and expanding description information based on the first image to obtain corresponding target description information; and
generating the second image based on the target description information.

Among them, the description information can be extracted based on the first image to obtain the corresponding first description information and style information, and the information expansion is performed based on the first description information and style information. Among them, the description information may refer to the information describing the specific content such as the objects, scenes, actions, etc. displayed in the image and their interconnections. For example, an image may include a little girl in red clothes feeding pigeons in the park. The description information of the image needs to identify and understand the various components in the image and their mutual relationship. The first description information may refer to the description information of the first image. The target description information may refer to the new description information generated after combining the style information, style weight and style prompt text based on the original description information. The target description information should not only retain the content description of the first image, but also add information that conforms to the specified style to make the description more specific. The style information may refer to the artistic expression of the image, including but not limited to the use of colors, the way of processing lines, the composition characteristics and the overall feeling. Specifically, the style information may refer to the style type, such as ordinary style, humorous style, abstract style, classical style, etc., and the style type may be preset.

In some embodiments, extracting description information and expanding information based on the first image to obtain corresponding target description information comprises:
extracting description information based on the first image to obtain first description information;
expanding the first description information once or multiple times; and
obtaining the target description information based on the result generated by each information expansion.

Among them, the first image can be expanded once, that is, the first description information is expanded once to obtain the target description information, and then the second image is generated based on the target description information. Specifically, the style of the first image can be transferred to the second image based on the style transfer model, and the image expansion is performed based on the diffusion model and the target description information to generate the second image. The style transfer model can be trained using a neural network and a corresponding large-scale data set. During training, content loss and style loss can be constructed. The content loss ensures that the output image is similar to the content image in structure; the style loss ensures that the output image captures the artistic style of the style image. Minimizing the weighted sum of these two loss functions until convergence can obtain the style transfer model. The diffusion model can gradually add noise to the image during training until the image is completely covered by noise. Then, the diffusion model starts from pure noise, gradually removes the noise and restores a clear image, thereby learning how to gradually build image details from small to large to generate images based on text descriptions or other conditional information.

In some embodiments, generating a second image based on the first image, the second image including image content of the first image, comprises:
generating a third image based on the first image, the third image including image content of the first image;
generating the second image based on the third image, the second image including the image content of the third image.

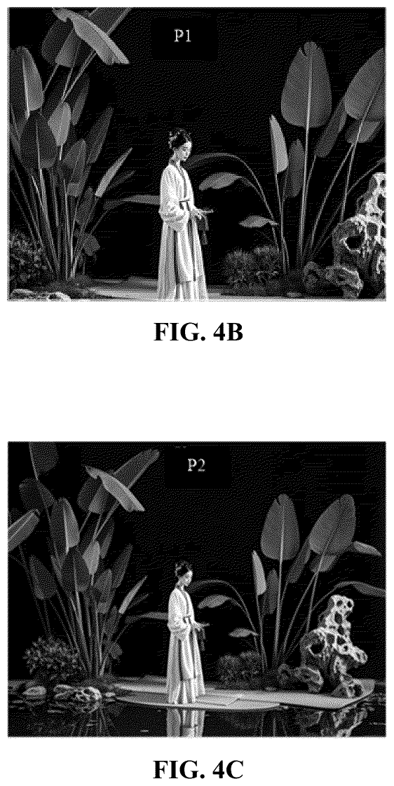

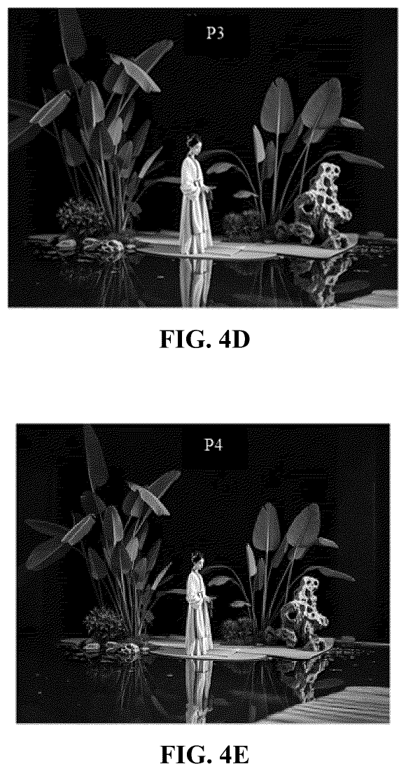

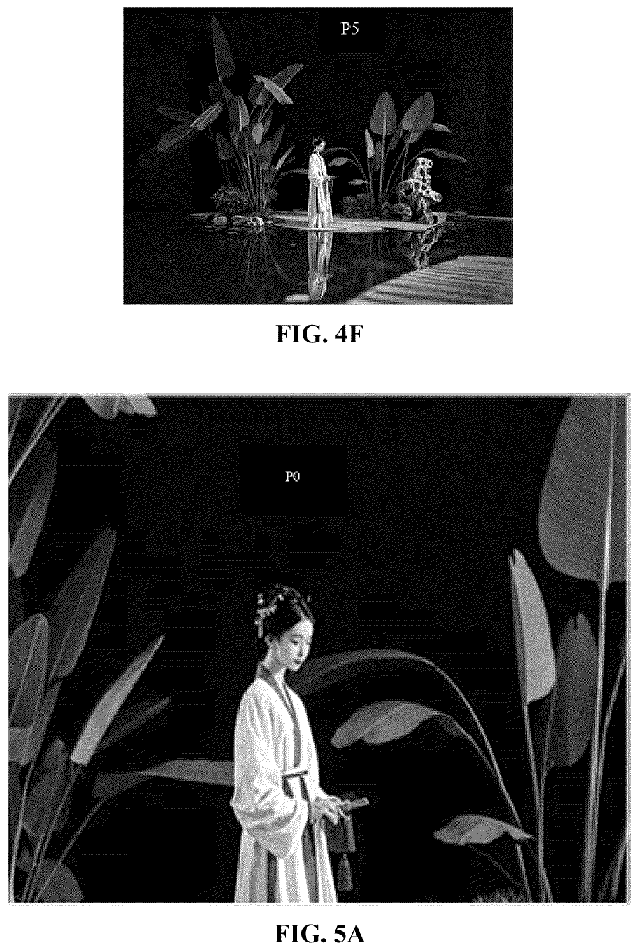

Among them, it is also possible to perform multiple image expansions on the first image, that is, perform multiple information expansions on the first description information to obtain the target description information, and then generate the second image based on the target description information. Specifically, as shown in FIG. 4A-4F, FIG. 4A-4F show schematic diagrams of generating the second image based on the first image according to an embodiment of the present disclosure. In FIG. 4A, information extraction can be performed on the first image P0 to obtain the first description information text0, and the first description information text0 can be expanded to obtain the second description information text1. The third image P1 is generated based on the second description information text1, as shown in FIG. 4B. The second description information text1 can be further expanded to obtain the third description information text2, and the second image P2 is generated based on the third description information text2, as shown in FIG. 4C. Furthermore, the third description information text2 can be further expanded to obtain the fourth description information text3, and the intermediate image P3 is generated based on the fourth description information text2, as shown in FIG. 4D. By analogy, new expanded images can be continuously generated based on the image obtained by the previous expansion, for example, the intermediate image P4 is generated based on the intermediate image P3, as shown in FIG. 4E. A second image P5 is generated based on the intermediate image P4, as shown in FIG. 4F.

In some embodiments, performing one or more information expansions on the first description information may further comprises:
extracting information based on the first image to obtain the corresponding style information; and
expanding the first description information once or multiple times based on the style weight and style corresponding to the style information to generate the target description information; wherein each information expansion is performed on the information expansion result obtained by the previous information expansion based on the style weight and the style prompt text.

Among them, the style weight can be a numerical value used to adjust the degree of style influence. When target description information is generated, the style weight can be used to control the strength of the newly added style-related description. The higher the style weight means that the target description information can contain more style elements, and vice versa, the lower the style weight, the target description information can contain fewer style elements. Style prompt text can be a prompt text used to guide the model on how to generate the target description based on the original description information and style information, and can include keywords, phrases, sentences or paragraphs to help the model better generate the target description information expected by the user, so that the target description information is more story-like and the scene or plot is richer while maintaining reasonable logic. For example, the first image P0 may be a sunset scene on a beach, and the corresponding original description information text0 may be “a golden sun is sinking above the horizon, and the sky is full of orange and purple clouds”, the style information style_0 may be “impressionism”, the style weight (the range may be [0,1]) may be s0, and the style prompt text prompt0 may be “emphasize the changes in light and shadow” or “describe the flow of colors”. Then, based on the language model, the original description information text0 of the first image P0 may be performed description information expansions according to the style information style_0, the style weight s0 and the style prompt text prompt0 to generate the target description information text1, which may be “the golden sun is slowly sinking above the sea level, and the orange and purple tones in the sky are mixed together to form a blurred and dreamy effect”.

Specifically, the target description information can be expanded multiple times in series, and the information expansion results obtained by each expansion can be used as the target description information. For example, the original description information text0 of the first image P0 can be performed description information expansions based on the language model according to the style information style_0, the style weight s0 and the style prompt text prompt0 to generate the target description information text1. Then, the target description information text1 can continue to be performed description information expansions according to the style information style_0, the style weight s0 and the style prompt text prompt0 to generate the target description information text2. Similarly, each description information expansion can be expanded on the result of the previous description information expansion. In this way, the target description information with high content relevance, consistent style and reasonable content logic can be generated based on the style information of the first image and the corresponding style prompt text based on the original description information.

In some embodiments, different style information corresponds to different style weights and different style prompt texts; the style weights are used to determine the stylization degree of the target description information generated based on the style prompt texts.

Among them, the style information and the style prompt text may have a corresponding mapping relationship, for example, style information 1 may correspond to preset style prompt text 1, and style information 2 may correspond to preset style prompt text 2. Once the style information of the first image is determined, the corresponding style prompt text may be determined. The style weight may be set based on user needs.

In some embodiments, obtaining the target description information based on the result generated by each information expansion; and generating a second image based on the target description information, comprising: generating corresponding multiple second images based on multiple pieces of the target description information.

Wherein, when the first description information is expanded multiple times, the second image may refer to the image generated corresponding to the information expansion result of each information expansion in the process of continuously expanding the description information. For example, the original description information text0 of the first image P0 may be performed description information expansions based on the language model according to the style information style_0, the style weight s0 and the style prompt text prompt0 to generate the target description information text1, and the second image P1 is generated based on the target description information text1. Then, the target description information text1 may be performed description information expansions according to the style information style_0, the style weight s0 and the style prompt text prompt0 to generate the target description information text2, and the second image P2 is generated based on the target description information text2. Then, the target description information text2 may be performed description information expansions according to the style information style_0, the style weight s0 and the style prompt text prompt0 to generate the target description information text3, and the second image P3 is generated based on the target description information text3. By analogy, the target description information obtained by each information expansion can generate a corresponding second image.

Compared with the prior art, the image processing method of the disclosed embodiment has a high degree of relevance between the theme of the second image and the first image after one or more expansions, thus avoiding the occurrence of incoordination; the content is more logically reasonable and conforms to the rules of the real world; the depiction of people or other creatures ensures that all parts of their bodies are intact, without missing limbs or disproportionate proportions; some creative elements are added to increase the fun without affecting the overall coordination; the expanded content is not limited to simple background filling, but enriches the story of the entire scene by adding more details, so that users can feel a deeper plot development; whether in color matching, line drawing or overall atmosphere, the expanded content maintains a style consistent with the original image, ensuring the unity and integrity of the entire work.

At step S330, dynamic scaling conversion is performed between the first image and the second image based on a preset speed to generate a target video.

Among them, by controlling the scaling speed of the second image, dynamic scaling conversion between the first image and the second image can be visually achieved, thereby ensuring smooth transition and ensuring generation of a coherent and visually attractive target video.

In some embodiments, performing dynamic scaling conversion between the first image and the second image based on a preset speed to generate a target video comprises:
determining the first and last frame of the target video based on the first image and the second image; and
performing dynamical reduction on the second image based on the preset speed, and/or performing dynamical enlargement on the second image based on the preset speed to obtain the target video.

Among them, the first image can be used as the first frame (first frame) of the target video, and the second image can be used as the final frame (last frame) of the target video, that is, the first image is displayed at the beginning of the target video, and the second image is displayed at the end. The second image can also be used as the first frame (first frame) of the target video, and the first image can be used as the final frame (last frame) of the target video, that is, the second image is displayed at the beginning of the target video, and the first image is displayed at the end. At this time, the size of the second image is dynamically changed based on the preset speed, which can be reduced or enlarged, so as to smoothly transition between these two states (i.e., the reduction or enlargement display between the first image and the second image of different sizes) in time and space, and a smooth animation effect is obtained, thereby ensuring the quality and viewing experience of the target video.

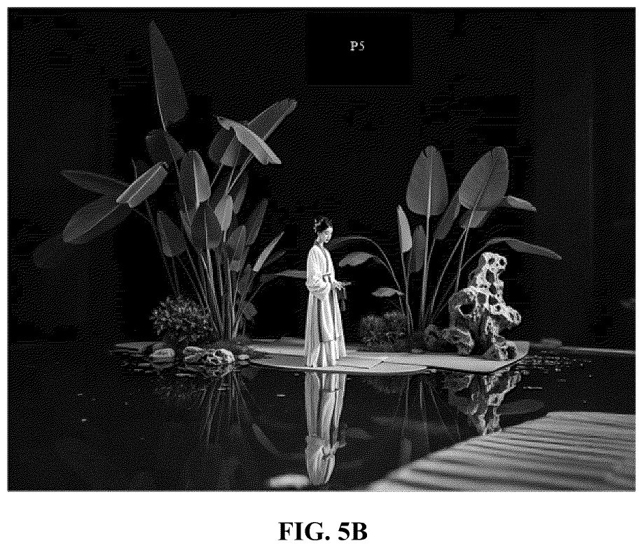

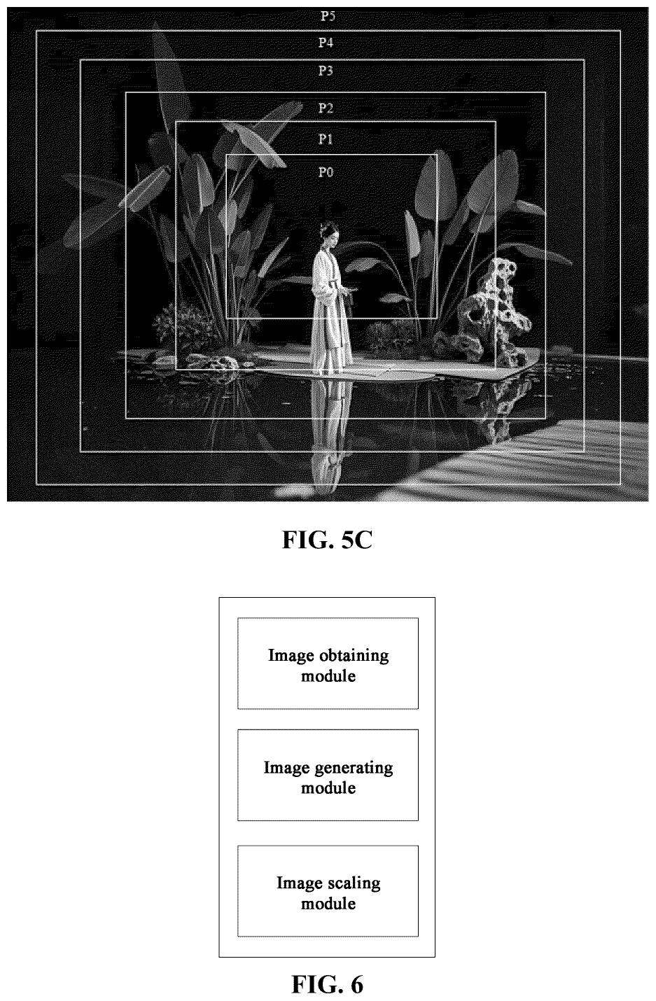

Specifically, referring to FIG. 5A-FIG. 5C, FIG. 5A-FIG. 5C show schematic diagrams of target videos according to embodiments of the present disclosure. Taking the first image P0 shown in FIG. 5A as the first frame of the target video and the second image P5 shown in FIG. 5B as the last frame of the target video as an example, the second image P5 can be gradually reduced based on a preset speed. Since the second image P5 is obtained by one or more image expansions on the first image P0, a visual effect of a continuous expansion of the image content of the first image P0 can be formed at this time, as shown in FIG. 5C. The second image P5 can also be gradually enlarged based on a preset speed to form a visual effect of a continuous enlargement of the image content of the second image P5, as shown in FIG. 5C.

In some embodiments, the preset speed includes a first preset speed and the second preset speed;
performing dynamic scaling conversion between the first image and the second image based on a preset speed to generate a target video comprises:
performing dynamic scaling conversion between the first image and the third image based on the first preset speed to generate a first intermediate video;
performing dynamic scaling conversion between the third image and the second image based on the second preset speed to generate a second intermediate video; and
obtaining the target video by splicing the first intermediate video and the second intermediate video.

Among them, the transition from the first image to the second image may include two stages, from the first image to the third image, and from the third image to the second image, and each stage may have different speed settings. The first preset speed may be used to control the dynamic scaling conversion between the first image and the third image, starting from the first image, and gradually the third image is displayed by scaling and changing the third image at the first preset speed. The second preset speed may be used to control the dynamic scaling conversion between the third image and the second image. Similar to the previous stage, starting from the third image, the second image is gradually displayed by scaling and changing the second image at the second preset speed. The first intermediate video and the second intermediate video of these two stages are connected in sequence to form a target video stream, which contains a complete transition effect from the first image to the second image through the third image. It should be understood that the above target video is only an example, and the scaling conversion of more images may be included between the first image and the second image, which is not limited here.

In some embodiments, the first preset speed and the second preset speed may be the same or different.

Among them, because the scaling conversion rate between each image can be controlled by adjusting different speeds, a more natural or dramatic visual effect is produced.

In some embodiments, performing a dynamic scaling conversion between the first image and the third image based on the first preset speed to generate a first intermediate video comprises:
determining the first image as a first frame of the first intermediate video, and determining the third image as a last frame of the first intermediate video; and
performing dynamic reduction on the third image based on the first preset speed, and/or performing dynamic enlargement on the third image based on the first preset speed to obtain the first intermediate video.

Among them, since the third image is generated based on the first image and is used to generate the second image, the third image will be used as the last frame of the first intermediate video and the first frame of the second intermediate time, so as to ensure the smoothness and logical rationality of the transition of scaling conversion between the first image and the second image. In the first intermediate video, the first image is used as the first frame and the third image is used as the last frame, and the third image is dynamically reduced and/or enlarged.

In some embodiments, performing dynamic scaling conversion between the third image and the second image based on the second preset speed to generate a second intermediate video comprises:
determining the third image as the first frame of the second intermediate video, and determining the second image as the last frame of the second intermediate video; and
performing dynamical reduction on the second image based on the second preset speed, and/or performing dynamical enlargement on the second image based on the second preset speed to obtain the second intermediate video.

Among them, in the second intermediate video, the third image is used as the first frame and the second image is used as the last frame, and the second image is dynamically reduced and/or enlarged. Specifically, as shown in FIG. 5C, the first image may be P0, the third image may be one or more of P2-P4, and the second image may be P5. The image P2, the image P3, the image P4, and the image P5 may be reduced or enlarged in sequence according to their respective preset speeds, and spliced to form a reduction or enlargement effect from image P0 to P5.

It can be seen that according to the image processing of the embodiment of the present disclosure, performing scaling conversion on the first image and the second image can form a specific visual effect, such as the zooming in or zooming out effect in a movie, or used to emphasize certain details in a video. By controlling the enlargement speed, these visual effects can be made more natural and attractive.

In some embodiments, method 300 further comprises: determining the preset speed based on a preset playback duration of the target video.

Among them, in order to ensure that the target video completes the change from the initial state to the final state within the preset playback time, it is necessary to determine the speed of reduction or enlargement according to the playback time. This is because the rate of change of each frame in the video directly affects the total duration of the video. Specifically, the time that the adjacent frames should occupy in each stage (reduction stage, enlargement stage) can be calculated according to the target duration of the target video. According to the time length of each stage, the speed required for reduction and enlargement is calculated. For example, if the total duration is fixed, and the time of the reduction and enlargement stage is fixed, then the speed of reduction or enlargement can be calculated accordingly. By adjusting the scaling speed of the second image in this way, a smooth transition from one state to another can be achieved. This means that whether it is reduction or enlargement, the changes in the video will not appear abrupt, but will occur in a gradual manner. At the same time, it is ensured that the total playback time of the video is consistent with the preset one, which can further improve the matching effect of audio and video for making a target video with a specific sense of rhythm or synchronized to external factors such as music.

In summary, the image processing technology provided by the present disclosure aims to ensure that the newly added parts can be seamlessly integrated with the original content in all aspects when expanding images or other media content in an intelligent way, thereby improving the overall visual effect and user experience. A target video can also be formed on this basis, so that the entire video looks like a continuous dynamic effect, which enhances the viewing experience and attractiveness. By carefully controlling the speed of change, a smooth and attractive visual effect can be created while ensuring the length of the video.

It should be noted that the method of the embodiment of the present disclosure can be performed by a single device, such as a computer or a server. The method of the present embodiment can also be applied in a distributed scenario and completed by multiple devices cooperating with each other. In the case of such a distributed scenario, one of the multiple devices can only perform one or more steps in the method of the embodiment of the present disclosure, and the multiple devices will interact with each other to complete the described method.

It should be noted that the above describes some embodiments of the present disclosure. Other embodiments are within the scope of the appended claims. In some cases, the actions or steps recorded in the claims can be performed in an order different from that in the above embodiments and still achieve the desired results. In addition, the processes depicted in the accompanying drawings do not necessarily require the specific order or continuous order shown to achieve the desired results. In some embodiments, multitasking and parallel processing are also possible or may be advantageous.

Based on the same technical concept, corresponding to any of the above-mentioned embodiments and methods, the present disclosure further provides an image processing apparatus, referring to FIG. 6, wherein the image processing apparatus comprises:
an image obtaining module, configured to obtain a first image;
an image generating module, configured to generate a second image based on the first image, the second image including image content of the first image; and
an image scaling module, configured to perform dynamic scaling conversion between the first image and the second image based on a preset speed to generate a target video.

For the convenience of description, the above device is described by dividing it into various modules according to its functions. Of course, when implementing the present disclosure, the functions of each module can be implemented in the same or multiple software and/or hardware.

The device of the above embodiment is used to implement the corresponding image processing method in any of the above embodiments, and has the beneficial effects of the corresponding method embodiment, which will not be described in detail here.

Based on the same technical concept, corresponding to any of the above-mentioned embodiment methods, the present disclosure also provides a non-transitory computer-readable storage medium, wherein the non-transitory computer-readable storage medium stores computer instructions, and the computer instructions are used to enable the computer to execute the image processing method described in any of the above embodiments.

The computer-readable medium of this embodiment includes permanent and non-permanent, removable and non-removable media, and information storage can be implemented by any method or technology. Information can be computer-readable instructions, data structures, modules of programs, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disk read-only memory (CD-ROM), digital versatile disk (DVD) or other optical storage, magnetic cassettes, tape disk storage or other magnetic storage devices or any other non-transmission media that can be used to store information that can be accessed by a computing device.

The computer instructions stored in the storage medium of the above embodiments are used to enable the computer to execute the image processing method described in any of the above embodiments, and have the beneficial effects of the corresponding method embodiments, which will not be repeated here.

It should be understood by those skilled in the art that the discussion of any of the above embodiments is merely illustrative and is not intended to imply that the scope of the present disclosure (including the claims) is limited to these examples; based on the concept of the present disclosure, the technical features in the above embodiments or different embodiments may be combined, the steps may be implemented in any order, and there are many other variations of different aspects of the embodiments of the present disclosure as described above, which are not provided in detail for the sake of simplicity.

In addition, to simplify the description and discussion, and in order not to obscure the embodiments of the present disclosure, known power/ground connections to integrated circuit (IC) chips and other components may or may not be shown in the provided figures. In addition, devices may be shown in the form of block diagrams to avoid obscuring the embodiments of the present disclosure, and this also takes into account the fact that the details of the implementation of these block diagram devices are highly dependent on the platform on which the embodiments of the present disclosure are to be implemented (i.e., these details should be fully within the scope of understanding of those skilled in the art). Where specific details (e.g., circuits) are set forth to describe exemplary embodiments of the present disclosure, it is apparent to those skilled in the art that the embodiments of the present disclosure may be implemented without these specific details or with variations in these specific details. Therefore, these descriptions should be considered illustrative rather than restrictive.

Although the present disclosure has been described in conjunction with specific embodiments of the present disclosure, many alternatives, modifications and variations of these embodiments will be apparent to those skilled in the art from the foregoing description. For example, other memory architectures (e.g., dynamic RAM (DRAM)) may use the discussed embodiments.

The embodiments of the present disclosure are intended to cover all such substitutions, modifications and variations that fall within the broad scope of the appended claims. Therefore, any omissions, modifications, equivalent substitutions, improvements, etc. made within the spirit and principles of the embodiments of the present disclosure should be included in the scope of protection of the present disclosure.

I/We claim:

1. An image processing method, comprising:
obtaining a first image;
generating, based on the first image, a second image, the second image comprising image content of the first image; and
generating a target video by performing dynamic scaling conversion between the first image and the second image based on a preset speed.

2. The method according to claim 1, wherein generating the target video by performing the dynamic scaling conversion between the first image and the second image based on the preset speed comprises:
determining, based on the first image and the second image, a first frame and a last frame of the target video; and
obtaining the target video by at least one of: dynamically reducing the second image based on the preset speed, or dynamically enlarging the second image based on the preset speed.

3. The method according to claim 1, wherein generating, based on the first image, the second image comprising the image content of the first image comprises:
generating, based on the first image, a third image comprising the image content of the first image; and
generating, based on the third image, the second image comprising image content of the third image.

4. The method according to claim 3, wherein the preset speed comprises a first preset speed and a second preset speed;
wherein generating the target video by performing the dynamic scaling conversion between the first image and the second image based on the preset speed comprises:
generating a first intermediate video by performing dynamic scaling conversion between the first image and the third image based on the first preset speed;
generating a second intermediate video by performing dynamic scaling conversion between the third image and the second image based on the second preset speed; and
obtaining the target video by performing splicing based on the first intermediate video and the second intermediate video.

5. The method according to claim 4, wherein generating the first intermediate video by performing the dynamic scaling conversion between the first image and the third image based on the first preset speed comprises:
determining the first image as a first frame of the first intermediate video, and determining the third image as a last frame of the first intermediate video; and
obtaining the first intermediate video by at least one of: dynamically reducing the third image based on the first preset speed, or dynamically enlarging the third image based on the first preset speed.

6. The method according to claim 5, wherein generating the second intermediate video by performing the dynamic scaling conversion between the third image and the second image based on the second preset speed comprises:
determining the third image as a first frame of the second intermediate video, and determining the second image as a last frame of the second intermediate video; and
obtaining the second intermediate video by at least one of: dynamically reducing the second image based on the second preset speed, or dynamically enlarging the second image based on the second preset speed.

7. The method according to claim 1, wherein generating, based on the first image, the second image comprises:
obtaining corresponding target description information by performing description information extraction and information expansion based on the first image; and
generating the second image based on the target description information.

8. The method according to claim 7, wherein obtaining the corresponding target description information by performing description information extraction and information expansion based on the first image comprises:
obtaining first description information by performing description information extraction based on the first image;
performing one or more information expansions on the first description information;
obtaining, based on a generated result of each information expansion, the target description information.

9. The method according to claim 1, further comprising:
determining, based on preset playing duration of the target video, the preset speed.

10. An electronic device, comprising a memory, a processor and a computer program stored in the memory and executable on the processor, wherein the computer program, when executed by the processor, causing the processor to:
obtain a first image;
generate, based on the first image, a second image, the second image comprising image content of the first image; and
generate a target video by performing dynamic scaling conversion between the first image and the second image based on a preset speed.

11. The electronic device according to claim 10, wherein the computer program causing the processor to generate the target video by performing the dynamic scaling conversion between the first image and the second image based on the preset speed comprises instructions to:
determine, based on the first image and the second image, a first frame and a last frame of the target video; and
obtain the target video by at least one of: dynamically reducing the second image based on the preset speed, or dynamically enlarging the second image based on the preset speed.

12. The electronic device according to claim 10, wherein the computer program causing the processor to generate, based on the first image, the second image comprising the image content of the first image comprises instructions to:
generate, based on the first image, a third image comprising the image content of the first image; and
generate, based on the third image, the second image comprising image content of the third image.

13. The electronic device according to claim 12, wherein the preset speed comprises a first preset speed and a second preset speed; wherein the computer program causing the processor to generate the target video by performing the dynamic scaling conversion between the first image and the second image based on the preset speed comprises instructions to:
generate a first intermediate video by performing dynamic scaling conversion between the first image and the third image based on the first preset speed;
generate a second intermediate video by performing dynamic scaling conversion between the third image and the second image based on the second preset speed; and
obtain the target video by performing splicing based on the first intermediate video and the second intermediate video.

14. The electronic device according to claim 13, wherein the computer program causing the processor to generate the first intermediate video by performing the dynamic scaling conversion between the first image and the third image based on the first preset speed comprises instructions to:
determine the first image as a first frame of the first intermediate video, and determine the third image as a last frame of the first intermediate video; and
obtain the first intermediate video by at least one of: dynamically reducing the third image based on the first preset speed, or dynamically enlarging the third image based on the first preset speed.

15. The electronic device according to claim 14, wherein the computer program causing the processor to generate the second intermediate video by performing the dynamic scaling conversion between the third image and the second image based on the second preset speed comprises instructions to:
determine the third image as a first frame of the second intermediate video, and determine the second image as a last frame of the second intermediate video; and
obtain the second intermediate video by at least one of: dynamically reducing the second image based on the second preset speed, or dynamically enlarging the second image based on the second preset speed.

16. The electronic device according to claim 10, wherein the computer program causing the processor to generate, based on the first image, the second image comprises instructions to:
obtain corresponding target description information by performing description information extraction and information expansion based on the first image; and
generate the second image based on the target description information.

17. The electronic device according to claim 16, wherein the computer program causing the processor to obtain the corresponding target description information by performing description information extraction and information expansion based on the first image comprises instructions to:
obtain first description information by performing description information extraction based on the first image;
perform one or more information expansions on the first description information;
obtain, based on a generated result of each information expansion, the target description information.

18. The electronic device according to claim 10, wherein the computer program further comprises instructions to:
determine, based on preset playing duration of the target video, the preset speed.

19. A non-transitory computer-readable storage medium, storing computer instructions for causing a computer to:
obtain a first image;
generate, based on the first image, a second image, the second image comprising image content of the first image; and
generate a target video by performing dynamic scaling conversion between the first image and the second image based on a preset speed.

20. The storage medium according to claim 19, the computer instructions for causing the computer to generate the target video by performing the dynamic scaling conversion between the first image and the second image based on the preset speed comprises instructions to:
determine, based on the first image and the second image, a first frame and a last frame of the target video; and
obtain the target video by at least one of: dynamically reducing the second image based on the preset speed, or dynamically enlarging the second image based on the preset speed.
